(19) United States
(12) Patent Application Publication
(10) Pub. No.: US 2015/0151688 A1
(43) Pub. Date: Jun. 4, 2015

(54) MOTOR VEHICLE WITH FIXATION DEVICE FOR A BICYCLE

(71) Applicant: GM GLOBAL TECHNOLOGY OPERATIONS LLC, Detroit, MI (US)

(72) Inventor: Wolfgang Back, Ruesselsheim (IT)

(21) Appl. No.: 14/554,980

(22) Filed: Nov. 26, 2014

(30) Foreign Application Priority Data
Nov. 30, 2013 (DE) 202013011014.7

(51) Int. Cl. B60R 11/00

(52) U.S. Cl. CPC B60R 11/00; B60R 2011/0036; B60R 2011/0052; B60R 2011/0071

(57) ABSTRACT

A fixation device for affixing a bicycle in a motor vehicle is disclosed. The fixation device includes a clamping plate for clamping between a stored item and a fastening plate. Two straps extend from the clamping plate and have a fixation port formed thereon for fixation on the fork. A fastener detachably secures the fixation port to the two straps.

### CROSS REFERENCE TO RELATED APPLICATION

This application claims priority to German Patent Application No. 202013011014.7 filed Nov. 30, 2013, which is incorporated herein by reference in its entirety.

### TECHNICAL FIELD

The present disclosure relates to a device for affixing a bicycle to a motor vehicle and in particular fixing a fork of the bicycle without a wheel in place inside the trunk of a motor vehicle, and a motor vehicle equipped with such a fixation device.

### BACKGROUND

In addition to a passenger compartment for accommodating individuals, motor vehicles also exhibit a trunk for accommodating luggage, e.g., suitcases. As so-called station wagons or sport utility vehicle (SUV), motor vehicles exhibit a tailgate on the trunk, which makes them so-called three- or five-door motor vehicles. Such vehicles exhibit a large trunk, so that a bicycle with large wheels (e.g., with 28″ wheels) can also be secured inside the trunk. For this purpose, the back section of the rear seats of the motor vehicle must be folded over, thereby enlarging the trunk space available, and the front wheel must be removed from the fork at the bicycle fork for the front wheel of the bicycle, so that a fixation device can be used to fix the end region of the fork where the front wheel of the bicycle is normally mounted inside the trunk of the motor vehicle. The fixation device is a bracket that rests on the top side of the trunk floor in a normal position and is aligned in the transverse direction, thus generally causing a handlebar of the bicycle to hit the tailgate, so that accommodating the bicycle inside the trunk disadvantageously requires that the tailgate of the motor vehicle be partially opened, as a result of which the tailgate is also partially opened while driving the motor vehicle, yielding the associated disadvantages, e.g., noise generation or moisture penetration when it rains.

US 2002/0000456 A1 discloses a device for transporting objects inside the trunk of a motor vehicle.

### SUMMARY

The present disclosure provides a fixation device for a bicycle and a motor vehicle, in which a bicycle can be securely fixed in a trunk of the motor vehicle even with the tailgate closed. In particular, the fixation device for a bicycle with which a fork of the bicycle can be fixed in place inside the trunk of a motor vehicle without a wheel on the fork. The fixation device encompasses a clamping plate for clamping between a stored item and a fastening plate, two straps, a fixation port for fixation on the fork, and a fastener for detachably securing the fixation port to the two straps. Because of its structural design, the fixation device can be used to easily affix an end region of the bicycle fork under the level of a trunk floor in a normal position of the trunk floor, i.e., in the area of a storage space under the trunk floor. As a result, the bicycle is situated inside the trunk and in the end region of the fork for the front wheel inside a storage space, thus preventing a handlebar of the bicycle from coming into contact with the closed tailgate of the motor vehicle. This makes it possible to advantageously secure and fix the bicycle completely inside the trunk using the fixation device with the tailgate closed.

The clamping plate exhibits a through opening for guiding through a fastening bolt for the stored item. The through opening can be easily fabricated on the clamping plate, for example by punching, and the fastening bolt for a stored item, for example a spare wheel inside the storage space, can as a result be guided through the through opening especially easily, and thereafter be arranged therein. As a result, the clamping plate is especially easy to clamp and/or positively and/or non-positively secure between the stored item and a fastening plate.

In one embodiment, the two straps and clamping plate are designed as a single piece, in particular as a single sheet metal part. The two straps are preferably aligned at essentially a right angle to the clamping plate. The two straps and clamping plate may be plate-shaped in design. The two straps may each exhibit an opening, in particular a borehole, for attaching the fixation port. The fastener may exert an axial force on the fixation port for securing the fork to the fixation port, with the fastener in particular encompassing a swiveling lever at a first end region of the fixation port and a retaining part detachably connected with the fixation port at a second end region. The fastener can be used to apply an axial force to the fixation port in the direction of a longitudinal axis of the latter, as a result of which the structural design of the fixation device non-positively secures the fork to the fixation device with a compressive force in the axial direction of the fixation port. The fixation port is arranged inside the slits on the arms of the fork, and the fork is clamped between the retaining part and/or at least one strap and/or at least one bushing and/or the swiveling lever and/or a fastener under a compressive force. The fastener preferably include several parts, e.g., exhibit a retaining part and/or a swiveling lever.

A motor vehicle according to the present disclosure include a drive motor, a body, a trunk, a trunk floor that can move at least partially between a normal position and a removal position, and a fixation device for a bicycle with which a bicycle fork without a wheel on the fork can be fixed inside the trunk. The fixation device is secured under the level of the trunk floor in the normal position, and the trunk floor is preferably at least partially located in the removal position. In the normal position of the trunk floor, the latter is essentially horizontally aligned, and the trunk floor separates a storage space from the trunk. The trunk floor, for example a first part of the trunk floor, can here at least partially be swiveled (i.e., is swivelable) and hence movable from the normal position into a removal position for removing stored items inside the storage space. This removal position of the trunk floor can be used to secure the fixation device under the level of the trunk floor in the normal position. In this way the end region of the bicycle fork is fixed inside the storage space and/or under the level of the trunk floor in the normal position inside the motor vehicle, thereby allowing there to be no contact between a bicycle handlebar and tailgate even with the tailgate completely closed.

In one embodiment, a storage space is formed under the trunk floor in the normal position for accommodating at least one stored item, in particular a spare tire of the motor vehicle. The stored item is preferably secured to the rest of the motor vehicle with a fastening device, in addition to which the fixation device is secured to the fastening device.

In one embodiment, the bicycle fork is a fork for a front wheel of the bicycle, and an end region of the fork is fixed with the fixation device under the level of the trunk floor in the normal position. The end region of the fork exhibits a respective slit on each arm of the fork, and this slit on the fork is normally used to fasten an axis of the front bicycle wheel. This slit can be used by the fixation device to reliably positively and/or non-positively secure the end region of the fork to the fixation device. The fastening device preferably exhibits a fastening bolt and a fastening plate that can be secured to the fastening bolt, and the fixation device is clamped between the stored item and the fastening plate secured to the fastening bolt.

In one embodiment, the fixation device is clamped onto a clamping plate between the stored item and fastening plate. The clamping plate of the fixation device is clamped between the stored item and fastening plate, i.e., positively and/or non-positively secured, so that the fixation device can be used to especially easily secure the bicycle, and in particular the fork, to the motor vehicle with the fastening device without any additional means. In particular, the motor vehicle encompasses the fixation device, and the fixation device is designed as a fixation device described in this application for a protective right.

### BRIEF DESCRIPTION OF THE DRAWINGS

The present disclosure will hereinafter be described in conjunction with the following drawing figures, wherein like numerals denote like elements.

FIG. 1 is a side view of a motor vehicle;

FIG. 2 is a perspective view of a trunk of the motor vehicle according to FIG. 1 with a bicycle fixed in the trunk;

FIG. 3 is a perspective view of the fork of a bicycle according to FIG. 2, which is fixed above a spare tire with a fixation device;

FIG. 4 is a perspective view of the spare tire and a fastening bolt without the fixation device, and

FIG. 5 is an exploded view of the fixation device according to FIG. 3.

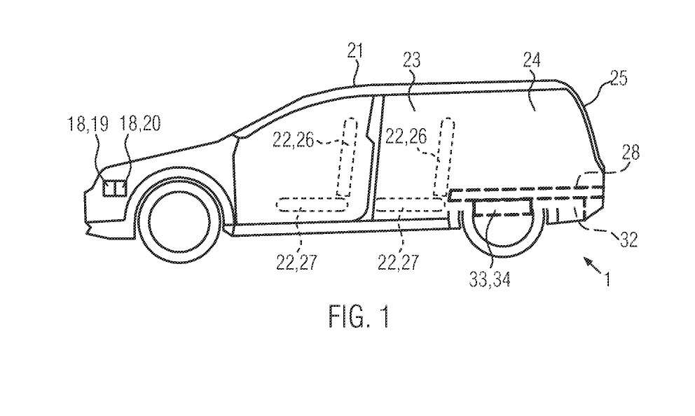

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

A motor vehicle 1 as a passenger car 1 exhibits a passenger compartment 23 for accommodating individuals or passengers. A drive motor 18, in particular a combustion engine 19 and/or electric engine 20, is used for powering the motor vehicle 1. A body 21 included of steel borders the passenger compartment 23 as well as a trunk 24 for accommodating luggage, for example a suitcase or purchased items. Positioned within the passenger compartment 23 are two front seats as vehicle seats 22 and three rear seats as vehicle seats 22. The vehicle seats 22 are joined together to form a seat bench. A vehicle seat 22 here exhibits a rear section 26 and a seat 27. In order to load and unload the trunk 24, a swivelable tailgate 25 can be used to remove luggage from and load it into the trunk 24. Given the geometric configuration of the trunk 24 and tailgate 25, the motor vehicle 1 may be configured as a so-called station wagon or sports utility vehicle (SUV), which has five doors. The trunk 24 is bordered at the lower end region by a trunk floor 28. The trunk floor 28 encompasses a first part 29 and a second part 30. The trunk floor 28 can here also be partially moved or is movable, because the first part 29 of the trunk floor 28 can be pivoted around a swiveling axis 31. In a normal position in which the trunk floor 28 is not swiveled and is essentially horizontally aligned, a storage space 32 is formed below the trunk floor 28, and bordered by the trunk floor 28 from above as well as by the body 11 from below and in the edge region. A spare tire 34 is kept inside the storage space 32 as a stored item 33. A tool kit can also be arranged inside the storage space 32 (not shown).

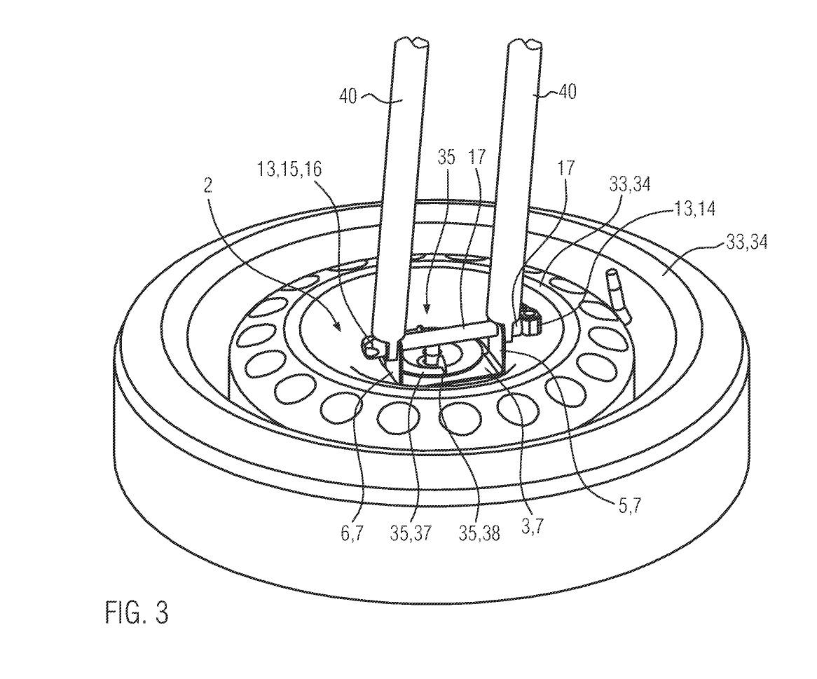

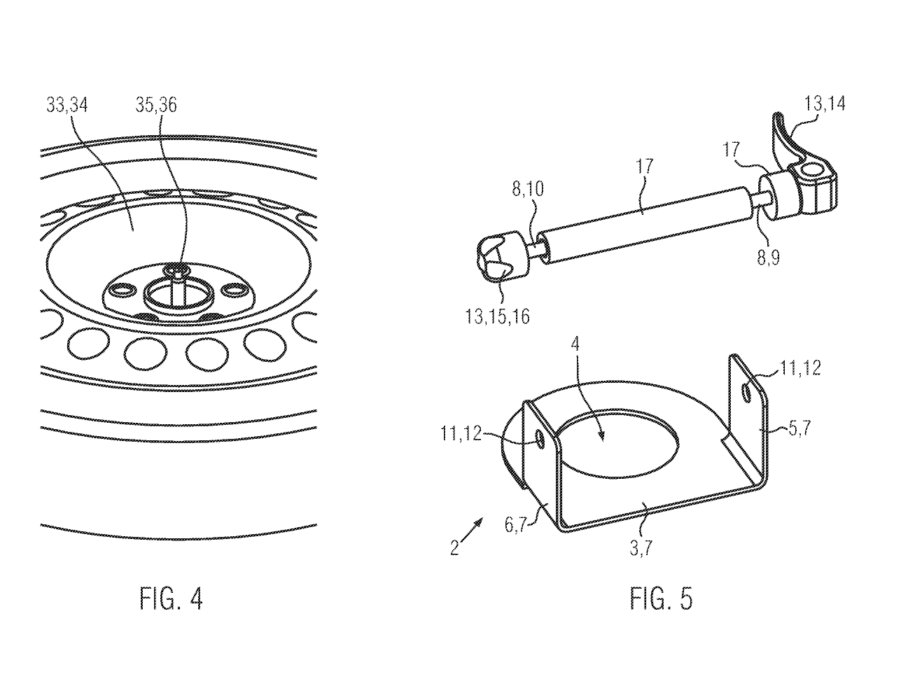

The spare tire 34 as the stored object 33 is secured inside the storage space 32 with a fastening device 35, so as to prevent the spare tire 34 from sliding inside the storage space 32. The fastening device 35 exhibits an essentially vertically aligned steel fastening bolt 36, which is secured to the body 21, for example welded on. In order to secure the spare tire 34 to the motor vehicle 1, the fastening bolt 36 is guided through the spare tire on a central region while placing the spare tire 34 in the storage space 32, thereby causing an upper end region of the fastening bolt 36 to protrude over the rest of the spare tire 34 (FIG. 4). A fastening plate 37 is then applied to the spare tire 34, and pressed onto the upper end region of the spare tire 34 with a fastening wing bolt 38, which is connected with the fastening bolt 36, in this way securing the spare tire 34 to the motor vehicle (FIG. 3).

The motor vehicle 1 is further provided with a fixation device 2 for fixing a bicycle 39 inside the trunk 24. The bicycle 39 exhibits a fork 40 as a front fork, and the longitudinal axis of the front bicycle wheel 39 is secured to two slits in the fork 40 during normal use of the bicycle 39. The fixation device 2 encompasses a clamping plate 3 as well as a first strap 5 and second strap 6. The clamping plate 3 in addition to the two straps 5, 6 are fabricated as a single part out of a sheet metal part 7 through forming, in particular bending, and punching. The two straps 5, 6 are aligned perpendicular to the clamping plate 3, and the clamping plate 3 further exhibits a through opening 4 for guiding through the fastening bolt 36. A respective opening 11 is punched out as a borehole 12 on the two straps 5, 6. On a rod-shaped, steel fixation port 8 of the fixation device 2 having an essentially constant diameter, a swiveling lever 14 is permanently secured on a first end region 9 of the fixation port 8 as one fastener 13, and a retaining part 15 can be detachably secured to a second end region 10 of the fixation port 8 as an attachment part 16. The attachment part 16 can here also exhibit a thread, with which the attachment part 16 can be screwed onto a thread at the second end region 10 of the fixation port 8. Two bushings 17 are also attached to the fixation ports 8.

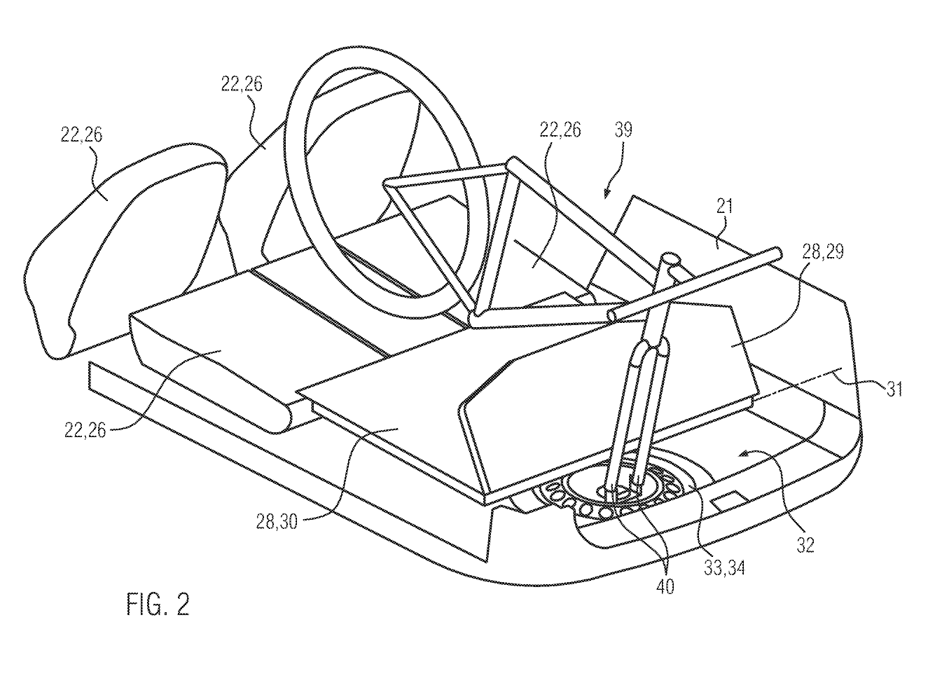

In order to fix the bicycle 39 inside the trunk 24, the front wheel of the bicycle 39 must first be disassembled from the fork 40. The fastening device 35 can then be detached, i.e., the fastening wing bolt 38 unscrewed from the fastening bolt 36, and the fastening plate 37 then removed. The clamping plate 3 is then placed onto the spare tire 34, and the fastening plate 37 is placed onto the clamping plate 3 of the fixation device 2. Fastening wing bolt 38 is screwed onto the fastening bolt, thereby non-positively clamping and securing the clamping plate 3 between the spare tire 34 and the fastening plate 37. In this way, the fastening device 35 can be easily used without any additional means for securing the fixation device 2 inside the motor vehicle 1. This is possible, since the first part 29 of the trunk floor 28 was to this end pivoted in advance around the swiveling axis 31 into a removal position as depicted on FIG. 2. In addition, the rear sections 26 of the back seats 22 can be swiveled, thereby enlarging the trunk 24 toward a front end of the motor vehicle 1.

In order to secure the fixation bolt 8 at the two openings 11 of the two straps 5, 6, only the first, shorter right bushing 17 depicted on FIG. 5 is initially to be slipped onto the fixation port 8. Thereafter, the fixation port 8 is slipped through the borehole 12 on the first strap 5, whereupon the second, longer left bushing 17 is positioned in the space between the two straps 5, 6 as depicted on FIG. 5. While continuing to insert the fixation port 8 into the borehole 12 on the first strap 5, the fixation port 8 is pushed into the second bushing 17 until a second end region 10 of the fixation port 8 is inserted and guided through the borehole 12 on the second strap 6. The attachment part 16 is then secured on the second end region 10 of the fixation port 8. On the two regions of the fixation port 8 visible on FIG. 5, the two slits can be slipped onto or into the arms of the fork 40, after which the swiveling lever 14 can be used to reduce the distance between the attachment part 16 and first bushing 17 shown on the right hand side of FIG. 5, which rests on the swiveling arm 14. In this manner the fork 40 is detachably secured to one arm of the fork between the two bushings 17 and to another arm of the fork 40 between the attachment part 16 and second strap 6 under exposure to a compressive force. In order to disassemble the fork 40 from the fixation device 2, the two processes described above must be correspondingly performed in reverse order.

Viewed as a whole, the fixation device 2 according to the present disclosure and the motor vehicle 1 according to the present disclosure are associated with significant advantages. The fixation device 2 can be used to fix the end region of the fork 40 under the level of the trunk floor 28 in the normal position in the storage space 32. As a result, even given bicycles 39 with larger wheels, e.g., 28″ wheels, the bicycle 39 can be fixed completely inside the trunk 24, and the tailgate 25 can nonetheless be completely closed without a handlebar of the bicycle 39 coming into contact with the tailgate 25. The fixation device 2 can be easily secured to the fastening device 35 for the bicycle 34, thus eliminating the need for any additional means for securing the fixation device 2 inside the motor vehicle 1.

While at least one exemplary embodiment was described, let it be noted that a larger number of variants thereto exist. It must also be kept in mind that the exemplary embodiment or exemplary embodiments only represent examples, and thus are not intended to in any way limit the protective scope, applicability or implementation or the structural design. The above specification provides the expert with suitable instructions for implementing at least one exemplary embodiment. Let it be understood that various changes can be made in the function and arrangement of the described components in an exemplary embodiment without deviating from the protective scope of the following claims and the equivalents to the following claims.

1-10. (canceled)

11. A fixation device for affixing a bicycle having a fork bicycle in place inside a trunk of a motor vehicle, the fixation device comprising:
a clamping plate configured to be clamped between a stored item in the truck and a fastening plate;
two straps extending from the clamping plate;
a fixation port configured to be releasably secured to the fork; and
a fastener for detachably securing the fixation port to the two straps.

12. The fixation device according to claim 11, wherein the clamping plate comprises a through opening formed therein configured to receive a fastening bolt to secure the clamping plate to the stored item.

13. The fixation device according to claim 11, wherein the two straps and the clamping plate are formed as a sheet metal part, and the two straps are substantially perpendicular to the clamping plate.

14. The fixation device according to claim 13, wherein the two straps and the clamping plate are plate-shaped.

15. The fixation device according to claim 11, wherein the two straps each comprise an opening for attaching the fixation port.

16. The fixation device according to claim 15, wherein the fastener can exerts an axial force on the fixation port for securing the fork to the fixation port.

17. The fixation device according to claim 16, wherein the fastener comprises a swiveling lever at a first end region of the fixation port and a retaining part detachably connected with the fixation port at a second end region.

18. A motor vehicle of the type having a drive motor, a body defining a trunk having a trunk floor, which can be moved at least partially between a normal position and a removal position, the motor vehicle further comprising a fixation device for a bicycle which can be used to affix a fork of the bicycle without a wheel inside the trunk, wherein the fixation device is secured under a level of the trunk floor in the normal position, and the trunk floor is preferably at least partially located in the removal position.

19. The motor vehicle according to claim 18, wherein a storage space is formed under the trunk floor in the normal position for accommodating at least one stored item.

20. The motor vehicle according to claim 19, wherein the stored item is secured to the body with a fastening device, wherein the fixing device is secured to the fastening device.

21. The motor vehicle according to claim 18, wherein the fork of the bicycle is a fork for a front wheel of the bicycle, and an end region of the fork is fixed with the fixation device under the level of the trunk floor in the normal position.

22. The motor vehicle according to claim 18, wherein the fastening device comprises a fastening bolt and a fastening plate secured to the fastening bolt, and wherein the fixation device is clamped between the stored item and the fastening plate secured to the fastening bolt.

23. The motor vehicle according to claim 22, wherein the fixation device is clamped onto a clamping plate between the stored item and fastening plate.

24. The motor vehicle according to claim 18, wherein the fixation device further comprises:
a clamping plate clamped between the stored item in the truck and a fastening plate;
two straps extending from the clamping plate;
a fixation port configured to be releasably secured to the fork; and
a fastener for detachably securing the fixation port to the two straps.
